(19) United States
(12) Patent Application Publication
(10) Pub. No.: US 2023/0055996 A1
(43) Pub. Date: Feb. 23, 2023

(54) ELECTROMECHANICAL BRAKE BOOSTER, VEHICLE BRAKE SYSTEM, SUBASSEMBLY THEREFOR AND SLIDING ELEMENT

(71) Applicant: ZF Active Safety GmbH, Koblenz (DE)

(72) Inventors: Kurt Wingender, Hartenfels (DE); Stefan Kammers, Oberstadtfeld (DE); José Manuel Calvo Martinez, Kruft (DE)

(21) Appl. No.: 17/887,076

(22) Filed: Aug. 12, 2022

(30) Foreign Application Priority Data
Aug. 20, 2021 (DE) 102021121701.6

(51) Int. Cl. F16H 19/04; B60T 13/74

(52) U.S. Cl. CPC F16H 19/04; B60T 13/745

(57) ABSTRACT

An electromechanical brake booster for a vehicle brake system is disclosed. The electromechanical brake booster has an actuating element which is couplable to an electric motor via a transmission, a housing in which the actuating element is displaceably received, and at least one sliding element which is arranged between the housing and the actuating element. A vehicle brake system, subassembly therefor and sliding element is also disclosed.

### CROSS-REFERENCE TO RELATED APPLICATION

This application claims priority to German Patent Application No. 102021121701.6, filed Aug. 20, 2021, the disclosure of which is incorporated herein by reference in its entirety.

### TECHNICAL FIELD

The disclosure relates to an electromechanical brake booster. The disclosure further relates to a vehicle brake system and a subassembly for a vehicle brake system. The disclosure further relates to a sliding element.

### BACKGROUND

Vehicle brake systems often have electromechanical brake boosters (electronic brake booster, EBB, EBB-actuators) which are driven by electric motors. In order to be able to generate a boost to the braking force by the brake booster, the rotational movement of the output shaft of the electric motor is converted into a translatory movement. Various devices for this purpose are known from the prior art.

For example, WO 2014/177691 A1 discloses a brake system with a master cylinder and electrical servo brake, with a transmission of the movement of the electric motor to a thrust rod of the master cylinder by two mechanisms, which are symmetrical relative to the axis of the system, for transmitting the movement of the electric motor to two toothed racks of a body of the electrical servo brake.

During a braking process, the rotational movement of the electric motor is transmitted by a transmission which engages in a toothing of an actuating element which is displaceably arranged in a housing of the brake booster, in order to move the actuating element in a translatory manner inside the housing. Due to the geometry of the toothing, lateral forces can occur from the toothing to the housing. This force can lead to friction and to wear on the housing, on the actuating element and on the toothing. Moreover, the housing and the actuating element are often produced from fibre-reinforced plastics, whereby it can also lead to further friction and wear between these two components. In particular, the glass fibre fillers in the plastics increase the friction and the wear.

### SUMMARY

An improved electromechanical brake booster mentioned in the introduction in terms of structure and/or function is needed. Moreover, the disclosure relates to an improved a vehicle brake system mentioned in the introduction as well as a subassembly for a vehicle brake system in terms of structure and/or function.

The object is achieved by an electromechanical brake booster having the features of claim 1. The object is further achieved by a subassembly for a vehicle brake system having the features of claim 18 and a vehicle brake system having the features of claim 19. The object is also achieved by a sliding element having the features of claim 20. Advantageous embodiments and/or developments form the subject matter of the subclaims.

An electromechanical brake booster can be for a vehicle. The electromechanical brake booster can be for a vehicle brake system. The vehicle can be a motor vehicle. The motor vehicle can be a passenger motor vehicle or truck. The brake booster can have an electric motor. The brake booster can have a thrust rod. The brake booster can have a transmission and/or a transmission subassembly. The transmission and/or the transmission subassembly can be operatively arranged between the electric motor and the thrust rod. The transmission and/or the transmission subassembly can be operatively arranged between the electric motor and an actuating element.

The electromechanical brake booster can permit and/or be configured for an electrically controlled intervention in a brake actuation. The electromechanical brake booster can serve and/or be configured to increase a brake pedal force. The electromechanical brake booster can act in the direction of a brake pedal force. The electromechanical brake booster can serve and/or be configured to actuate a brake independently of a brake pedal force. The electromechanical brake booster can serve and/or be configured to attenuate a brake pedal force. The brake booster can act counter to a brake pedal force. The electromechanical brake booster can serve and/or be configured to simulate a brake pedal force. The electromechanical brake booster can serve and/or be configured to actuate a brake in an automated or semi-automated manner. The electromechanical brake booster can permit a purely mechanical actuation of a brake by means of a brake pedal.

The electromechanical brake booster can have an actuating element. The actuating element can be couplable to an electric motor via a transmission or can be configured therefor. The electromechanical brake booster can have a housing such as a main housing. The actuating element can be arranged in the housing. The actuating element can be displaceably received in the housing. The actuating element can be slidably received in the housing. The housing can have a substantially cylindrical recess and/or bore. The actuating element can be arranged, for example displaceably and/or slidably received, in the recess and/or bore of the housing.

The electromechanical brake booster can have at least one sliding element. The at least one sliding element can be arranged between the housing and the actuating element. The at least one sliding element can be arranged between the actuating element and a wall, such as an inner wall, the recess and/or bore of the housing. The at least one sliding element can be arranged on a load side of the actuating element. The at least one sliding element can be arranged on a side remote from or facing the transmission of the electromechanical brake booster. The at least one sliding element can have a substantially triangular and/or trapezoidal and/or curved and/or rounded shape in cross section.

The at least one sliding element can be configured to mount the actuating element in the housing, for example in the recess and/or bore of the housing, in a displaceable and/or sliding manner. The at least one sliding element can be configured to increase a contact, in particular a contact surface, between the actuating element and the housing. The at least one sliding element can extend substantially in the direction of a longitudinal axis of the actuating element. The at least one sliding element can extend substantially parallel to the longitudinal axis of the actuating element.

The at least one sliding element can be arranged in a direction transversely, for example substantially perpendicularly, to the longitudinal axis of the actuating element between the housing and the actuating element. This direction can be a first direction such as a first transverse direction. The at least one sliding element can be arranged between the housing and a surface running substantially parallel to the longitudinal axis of the actuating element, such as the outer surface and/or lateral surface of the actuating element. The at least one sliding element can be arranged between the housing and a section of the actuating element running substantially parallel to the longitudinal axis of the actuating element. The surface, such as the outer surface and/or lateral surface, and/or the section of the actuating element can be arranged and/or provided on a side remote from or facing the transmission of the electromechanical brake booster.

The at least one sliding element can be arranged between the actuating element and a section of the housing running substantially parallel to a longitudinal axis of the housing and/or the actuating element. The at least one sliding element can be arranged between the actuating element and a surface such as an inner surface of the housing running substantially parallel to a longitudinal axis of the housing and/or the actuating element. The at least one sliding element can be arranged between the actuating element and a surface such as an inner surface of the recess and/or bore of the housing running substantially parallel to a longitudinal axis of the recess and/or bore of the housing and/or the actuating element. The section of the housing and/or the surface such as the inner surface of the housing and/or the surface such as the inner surface of the recess and/or bore of the housing can be arranged and/or provided on a side remote from or facing the transmission of the electromechanical brake booster.

No further components can be located between the at least one sliding element and the housing. In addition to the at least one sliding element, no further components can be located between the actuating element and the housing.

The at least one sliding element can protrude at least in some sections from the surface, such as the outer surface and/or lateral surface, of the actuating element and/or from the section of the actuating element, for example substantially in the radial direction and/or in the direction of the housing. The at least one sliding element can protrude or project at least in some sections over the surface, such as the outer surface and/or lateral surface, of the actuating element and/or over the section of the actuating element, for example substantially in the radial direction and/or in the direction of the housing.

The actuating element can have a ribbed structure at least in some sections. The ribbed structure can be of arcuate configuration. The ribbed structure can be configured in an arcuate manner in the direction of a circular arc about the longitudinal axis of the actuating element. The ribbed structure can have a plurality of ribs. The ribs of the ribbed structure can extend substantially parallel to the longitudinal axis of the actuating element. The ribs of the ribbed structure can extend in a direction substantially transversely, for example perpendicularly, to the longitudinal axis of the actuating element. A plurality of ribs of the ribbed structure can be arranged substantially perpendicularly to one another. A plurality of ribs of the ribbed structure can be arranged substantially parallel to one another. The ribbed structure can define and/or at least form in some sections the surface, such as the outer surface and/or lateral surface, of the actuating element. The ribbed structure can be arranged and/or provided on a side remote from or facing the transmission of the electromechanical brake booster.

The at least one sliding element can be arranged on the ribbed structure. The at least one sliding element can be integrated at least in some sections in the ribbed structure. The at least one sliding element can have a sliding section. The at least one sliding element can have a fastening section. The fastening section can be configured to hold, for example fixedly hold, such as captively hold or fix, the at least one sliding element on the actuating element. The sliding section of the at least one sliding element can be arranged and/or provided on a side facing the housing. The sliding section of the at least one sliding element can be arranged and/or provided radially outwardly relative to the longitudinal axis of the actuating element. The fastening section of the at least one sliding element can be arranged and/or provided on a side remote from the housing. The fastening section of the at least one sliding element can be arranged and/or provided radially inwardly relative to the longitudinal axis of the actuating element. The actuating element can have a section which cooperates with the fastening section of the at least one sliding element for fastening and/or for positioning the at least one sliding element on the actuating element. The ribbed structure can be configured to cooperate with the fastening section of the at least one sliding element for fastening and/or for positioning the at least one sliding element on the actuating element. The section and/or the ribbed structure can receive the fastening section at least in some sections. The section and/or the ribbed structure can be configured to be stepped and/or coupled to the fastening section of the at least one sliding element. The stepped section and/or the stepped ribbed structure of the actuating element can be formed by a section with a smaller diameter and a section with a larger diameter which are connected, for example, via a step and/or shoulder.

The at least one sliding element and/or the fastening section of the at least one sliding element can be configured to be latched to the actuating element. The at least one sliding element and/or the fastening section of the at least one sliding element can have at least one latching projection and/or at least one latching lug. The at least one latching projection and/or the at least one latching lug can engage and/or latch in the stepped section and/or in the ribbed structure of the actuating element.

The at least one sliding element and/or the fastening section of the at least one sliding element can be fixedly connected to the actuating element. The at least one sliding element and/or the fastening section of the at least one sliding element can be connected by a material connection to the actuating element. The at least one sliding element and/or the fastening section of the at least one sliding element can be connected by a non-positive connection to the actuating element. The at least one sliding element and/or the fastening section of the at least one sliding element can be bonded, welded, pressed, clamped or latched to the actuating element. The at least one sliding element and/or the fastening section of the at least one sliding element can be clipped on the actuating element.

The at least one sliding element and/or the actuating element can be produced by an injection-moulding method, for example a multi-component injection-moulding method, such as a two-component injection-moulding method (2C method). The actuating element can be produced or is to be produced by the first component of a two-component injection-moulding method. The at least one sliding element can be produced or is to be produced by the second component of a two-component injection-moulding method. The at least one sliding element and/or the actuating element can be produced or are to be produced substantially at the same time or directly or immediately one after the other by a two-component injection-moulding method.

The at least one sliding element can be produced from an elastically and/or plastically deformable material. The at least one sliding element can be produced from plastics. The at least one sliding element can be produced from a non-fibre-reinforced plastics. The plastics can be a thermoplastics material, for example a polyoxymethylene.

The actuating element can be produced from plastics. The actuating element can be produced from fibre-reinforced plastics, for example from glass fibre-reinforced and/or carbon fibre-reinforced plastics. The plastics can be a thermoplastics material. The actuating element can be produced from metal, such as steel or aluminium. The actuating element can be a hybrid component which is produced in some sections from metal and in some sections from plastics.

The housing can be produced from plastics. The housing can be produced from fibre-reinforced plastics, for example from glass fibre-reinforced and/or carbon fibre-reinforced plastics. The plastics can be a thermoplastics material. The housing can be produced from metal, such as steel or aluminium. The housing can be a hybrid component which is produced in some sections from metal and in some sections from plastics.

A lubricant can be arranged and/or can be operative between the housing and the actuating element. A lubricant can be arranged and/or can be operative between the housing and the at least one sliding element. The lubricant can be fluid, viscous or pasty.

The electromechanical brake booster can have two sliding elements. The two sliding elements can be configured and/or arranged as described above and/or below. The two sliding elements can be arranged spaced apart from one another in a direction transversely, for example substantially perpendicularly, to the longitudinal axis of the actuating element. This direction can be a second direction, such as a second transverse direction. The second direction can be substantially perpendicular to the first direction. The first direction and the second direction can be perpendicular to one another. The first direction and the second direction can be perpendicular to the longitudinal axis of the actuating element.

The actuating element can have at least one tooth row section. The at least one tooth row section can be couplable to the electric motor via the transmission. The transmission can be a spur gear which is driven by the electric motor and which is coupled to the at least one tooth row section. The rotational movement output by the electric motor can be converted by the tooth row section into a translatory movement of the actuating element. The at least one tooth row section can have driving teeth. The driving teeth can have an involute toothing, spur toothing or helical toothing. The at least one tooth row section can be a toothed rack section. The actuating element can be a toothed rack module. The actuating element can have a sleeve-like or cylindrical shape. The actuating element can have a recess extending along the longitudinal axis. The actuating element can have an annular cross section. The actuating element can have an inner face and an outer face in the radial direction. The actuating element can have longitudinal guides. The longitudinal guides can be arranged on the inner face. The at least one tooth row section can be arranged on the outer face.

The actuating element can have a single tooth row section. The actuating element can be designed as a single toothed rack module. The actuating element can have two tooth row sections. The actuating element can have a first tooth row section and a second tooth row section. The first tooth row section and the second tooth row section can be arranged diametrically opposite one another, for example relative to the longitudinal axis of the actuating element. The two tooth row sections can be arranged opposingly in a direction transversely, for example substantially perpendicularly, to the longitudinal axis of the actuating element. For example, the two tooth row sections can be arranged opposingly in the direction of the second direction. The actuating element can be designed as a double toothed rack module. Each tooth row section of the actuating element can be brought into engagement or can be in engagement with a gear wheel or a spur gear of the transmission. The actuating element can serve to form a toothed rack drive in engagement with at least one gear wheel.

A subassembly can be for a vehicle brake system. The subassembly can have at least one electromechanical brake booster. The at least one electromechanical brake booster can be configured as described above and/or below. The subassembly can have at least one brake cylinder such as a brake master cylinder. The at least one brake cylinder can be couplable or coupled fluidically to at least one brake circuit of the vehicle brake system. The at least one electromechanical brake booster can be couplable or coupled to the at least one brake cylinder so as to transmit force and/or serve and/or be configured to actuate the at least one brake cylinder.

The brake cylinder can be attached to the housing of the electromechanical brake booster. The brake cylinder can have a cylinder longitudinal axis. The longitudinal axis of the actuating element or the at least one tooth row section thereof can be arranged or arrangeable coaxially to the cylinder longitudinal axis. The longitudinal axis of the actuating element or the at least one tooth row section thereof can be arranged or arrangeable coaxially to the cylinder longitudinal axis in an installed position of the brake booster.

The thrust rod can have a thrust rod longitudinal axis. The thrust rod longitudinal axis and the longitudinal axis of the actuating element or the at least one tooth row section thereof can be arranged coaxially to one another. The actuating element can be fixedly connectable to the thrust rod for transmitting a mechanical power in the extension direction of the longitudinal axis or the thrust rod longitudinal axis, in order to permit a brake actuation by the electric motor. A connection between the actuating element and the thrust rod can be releasable in order to permit a brake actuation which is independent of the electric motor.

The brake cylinder can have at least one pressure piston. The at least one pressure piston can be couplable or coupled to the thrust rod. The at least one pressure piston can be displaceably received in at least one pressure chamber. At least one brake circuit of the vehicle brake system can be subjected to hydraulic brake pressure via the pressure piston. The pressure piston can be subjected to the boost power of the brake booster and/or to the actuating force generated by the driver, in order to generate the desired braking pressure on the wheel brakes connected to the brake cylinder.

The subassembly can have the transmission via which the actuating element or the at least one tooth row section can be couplable or coupled to the electric motor. The transmission can be a spur gear. The transmission can serve and/or be configured to convert a rotational movement into a linear movement. The transmission can be driven by the electric motor.

The subassembly can have the electric motor. The electric motor can be a DC motor. The electric motor can be a brushless DC motor. The electric motor can be an electronically commutated brushless DC motor. The electric motor can be synchronous motor. The electric motor can be controllable by means of an electrical control device. The electrical control device can be a control unit and/or a control apparatus. The electrical control device can have a computing device. The electrical control device can have a memory device. The electrical control device can have at least one signal input. The electrical control device can have at least one signal output.

A vehicle brake system can be for a vehicle. The vehicle brake system can have a subassembly which is configured as described above and/or below. The vehicle brake system can have an electromechanical brake booster which is configured as described above and/or below.

The vehicle can be a motor vehicle. The motor vehicle can be a passenger motor vehicle or truck. The vehicle can have at least one machine for a propulsion drive. The vehicle can have at least one drivable vehicle wheel. The vehicle can have a vehicle brake system. The vehicle brake system can be configured as described above and/or below. The vehicle brake system can have at least one brake device. The at least one brake device can serve and/or be configured to brake at least one vehicle wheel. The at least one brake device can be a parking brake device. The at least one brake device can be a service brake device. The at least one brake device can be a dual-circuit or multi-circuit brake device. The at least one brake device can be a hydraulic brake device. The at least one brake device can have a brake cylinder such as a brake master cylinder. The at least one brake device can have the brake booster. The at least one brake device can be a brake pedal, a brake fluid reservoir, a brake pressure distributor, a pipe system, brake hoses, wheel brake cylinders and/or ventilation valves.

A sliding element can be and/or can be configured for an electromechanical brake booster. The electromechanical brake booster can comprise an actuating element which is couplable to an electric motor via a transmission and a housing in which the actuating element can be displaceably received. The electromechanical brake booster can be configured as described above and/or below. The sliding element can be configured in order to be arranged between the housing and the actuating element. The sliding element can be configured and/or arranged as described above and/or below.

In other words, at least one friction-reducing and/or wear-reducing element, such as a pad, can be provided for an actuating element, such as an EBB rack, of an electromechanical brake booster. The element or pad can be a sliding element or sliding pad and/or a sliding cushion which is attached to the EBB rack. A direct contact of the EBB rack with the main housing can be replaced thereby. By a replacement of the direct contact between the main housing and the EBB rack by the special sliding pad, the contact surface can be increased and the friction and the wear markedly reduced. The sliding pad can be produced from plastics without fibres, such as glass fibres, or without a fibre component. The plastics can be a polyoxymethylene (POM). A plurality of sliding pads can be provided, for example two thereof. The sliding pads can be arranged and/or fastened to the main body of the EBB rack. A lubrication can be provided. The sliding pads can be arranged/fastened or implemented on the EBB rack by bonding, welding, pressing, clipping or two-component injection-moulding. The rack side which is not normally loaded with radial loads does not have to be changed. Two sliding elements/pads can be attached to the load side of the rack. The remaining sections of the rack guide ribs can be treated or are to be treated in order to avoid or reduce the contact with the housing.

The exemplary arrangements of the disclosure provides for the reduction of the friction and/or the wear. The contact surface can be increased. The contact pressure can be reduced. A larger number of load cycles can be achieved. The performance can be improved. The behaviour can be more stable, for example relative to a stick-slip effect/stick-slipping (“stick-slip movements”).

### BRIEF DESCRIPTION OF DRAWINGS

Exemplary arrangements of the disclosure are described in more detail hereinafter with reference to the figures, in which schematically and by way of example:

FIG. 1 shows an actuating element;

FIG. 2 shows the actuating element according to FIG. 1 with two sliding elements; and

FIG. 3 shows an electromechanical brake booster.

### DETAILED DESCRIPTION

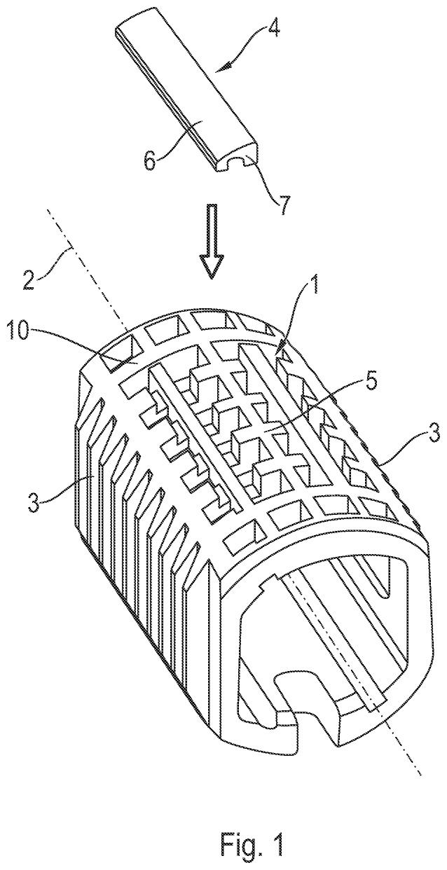

FIG. 1 shows schematically an actuating element 1 of an electromechanical brake booster 8. The actuating element 1 is configured as a toothed rack module and has two tooth row sections 3 arranged diametrically opposing one another relative to the longitudinal axis 2 of the actuating element 1. The actuating element 1 is couplable by its tooth row sections 3 via a transmission to an electric motor.

Moreover, at least one sliding element 4 is provided, said sliding element being applied onto an arcuate ribbed structure 5 of the actuating element 1 or being fixedly arranged thereon (illustrated by the arrow in FIG. 1). The ribbed structure 5 defines or forms an outer surface 10 of the actuating element 1. The at least one sliding element 4 has a sliding section 6 and a fastening section 7 which can hold the at least one sliding element 4 on the actuating element 1.

The at least one sliding element 4 and/or the actuating element 1 is produced by an injection-moulding method. In one exemplary arrangement, the at least one sliding element 4 is produced from non-fibre-reinforced plastics, for example thermoplastics material, such as polyoxymethylene (POM).

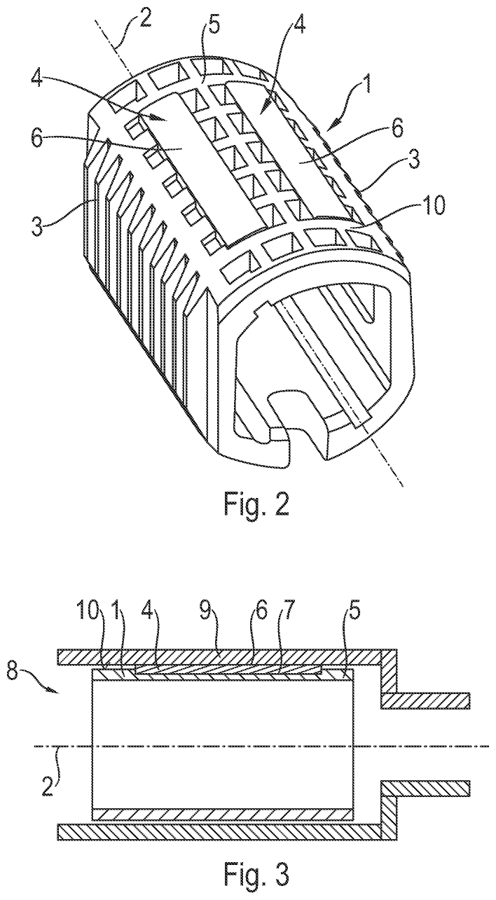

FIG. 2 shows schematically the actuating element 1 according to FIG. 1 to which two sliding elements 4 have been fastened. The two sliding elements 4 extend in each case substantially in the direction of the longitudinal axis 2 of the actuating element 1. The sliding elements 4 are arranged spaced apart from one another in a direction transversely, for example perpendicularly, to a longitudinal axis 2 of the actuating element 1.

The two sliding elements 4 are fixedly connected or latched by their fastening section 7 to the actuating element 1 and thus captively attached to the actuating element 1. The two sliding elements 4 protrude in some sections from the outer surface 10 of the actuating element 1 or project thereover, for example substantially in the radial direction.

Moreover, reference is additionally made to FIG. 1 and the associated description.

FIG. 3 shows schematically an electromechanical brake booster 8 for a vehicle brake system. The electromechanical brake booster 8 has the actuating element 1 with the sliding elements 4 according to FIGS. 1 and 2. The electromechanical brake booster 8 also has a housing 9. The actuating element 1 is displaceably received in the housing 9.

The sliding elements 4 are arranged between the housing 9 and the actuating element 1, wherein the sliding elements 4 are configured to mount the actuating element 1 displaceably and/or slidably in the housing 9.

The sliding elements 4 are arranged in a direction transversely, in one exemplary arrangement, perpendicularly, to the longitudinal axis 4 of the actuating element 1 between the housing 9 and the actuating element 1. In one exemplary arrangement, the sliding elements 4 are arranged between the outer surface 10 of the actuating element 1, running substantially parallel to the longitudinal axis 2 of the actuating element 1, and the housing 9, wherein the sliding elements 4 protrude in some sections from the outer surface 10 of the actuating element 1 in the direction of the housing 9.

A lubricant can be additionally arranged and/or can be operative between the housing 9 and the actuating element 1 and/or the sliding element 4.

Moreover, reference is additionally made to FIGS. 1 and 2 and the associated description.

Optional features of the disclosure are denoted, in particular, by “can”. Accordingly, there are also developments and/or exemplary arrangements of the disclosure which additionally or alternatively comprise the respective feature or the respective features.

Isolated features can also be singled out from the presently disclosed combinations of features, if required, and used in conjunction with other features, by breaking up a structural and/or functional relationship potentially existing between the features in order to limit the subject matter of the claims.

1. An electromechanical brake booster for a vehicle brake system, comprising an actuating element which is couplable to an electric motor via a transmission, a housing in which the actuating element is displaceably received, and at least one sliding element which is arranged between the housing and the actuating element.

2. The electromechanical brake booster according to claim 1, wherein the at least one sliding element is configured to mount the actuating element in the housing in a displaceable and/or slidable manner.

3. The electromechanical brake booster according to claim 1, wherein the at least one sliding element is arranged in a direction transversely to a longitudinal axis of the actuating element between the housing and the actuating element.

4. The electromechanical brake booster according to claim 1, wherein the at least one sliding element is arranged between a surface, of the actuating element, running substantially parallel to the longitudinal axis of the actuating element, and the housing.

5. The electromechanical brake booster according to claim 1, wherein the at least one sliding element protrudes at least in some sections from a surface of the actuating element.

6. The electromechanical brake booster according to claim 1, wherein the actuating element has a ribbed structure at least in some sections, wherein the at least one sliding element is arranged on the ribbed structure and/or wherein the ribbed structure defines a surface of the actuating element.

7. The electromechanical brake booster according to claim 1, wherein the at least one sliding element extends substantially in a direction of the longitudinal axis of the actuating element.

8. The electromechanical brake booster according to claim 1, wherein the at least one sliding element has a sliding section and a fastening section which holds the at least one sliding element on the actuating element.

9. The electromechanical brake booster according to claim 1, wherein the at least one sliding element and/or a fastening section of the at least one sliding element is configured to be latched to the actuating element.

10. The electromechanical brake booster according to claim 1, wherein the at least one sliding element and/or a fastening section of the at least one sliding element is fixedly connected to the actuating element.

11. The electromechanical brake booster according to claim 1, wherein the at least one sliding element and/or the actuating element is produced by an injection-moulding operation.

12. The electromechanical brake booster according to claim 1, wherein the at least one sliding element and/or the actuating element and/or the housing (9) is produced from plastics.

13. The electromechanical brake booster according to claim 1, wherein the actuating element and/or the housing is produced from fibre-reinforced plastics.

14. The electromechanical brake booster according to claim 1, wherein the at least one sliding element is produced from a non-fibre-reinforced plastics.

15. The electromechanical brake booster according to claim 1, wherein a lubricant is arranged and/or is operatively positioned between the housing and the actuating element and/or the at least one sliding element.

16. The electromechanical brake booster according to claim 1, wherein the electromechanical brake booster has two sliding elements which are arranged spaced apart from one another in a direction transversely to a longitudinal axis of the actuating element.

17. The electromechanical brake booster according to claim 1, wherein the actuating element has at least one tooth row section which is couplable to the electric motor via the transmission.

18. A subassembly for a vehicle brake system having at least one electromechanical brake booster according to claim 1, and at least one brake cylinder which is couplable fluidically to at least one brake circuit of the vehicle brake system.

19. A vehicle brake system having a subassembly according to claim 18.

20. A sliding element for an electromechanical brake booster, wherein the electromechanical brake booster comprises an actuating element which is couplable to an electric motor via a transmission and a housing, in which an actuating element (1) is displaceably received, wherein a sliding element is configured to be arranged between the housing and the actuating element.
